(19) United States
(12) Patent Application Publication
(10) Pub. No.: US 2012/0080285 A1
(43) Pub. Date: Apr. 5, 2012

(54) CLUTCH DEVICE FOR A SCREW DRIVER

(76) Inventor: HO-TIEN CHEN, TAINAN CITY (TW)

(21) Appl. No.: 12/896,811

(22) Filed: Oct. 1, 2010

(51) Int. Cl. F16D 11/12

(52) U.S. Cl. 192/71

(57) ABSTRACT

A clutch device for a screw driver includes a shell and a clutch received in an accommodating chamber of the shell. The clutch is composed of a driven rod base, a driven wheel and a center wheel. The driving rod base is formed with a driving rod groove for receiving a driving rod that drives a screw in an object, and a center shaft groove for receiving the center shaft and positioning bead holes for receiving positioning beads. The driven wheel is fixed in place by a shock-preventing member and formed with a groove for receiving one end of the driving rod base. The clutch can automatically function to let the drive wheel of an electric tool engage or disengage from the driven wheel in driving a screw to a preset depth in an object, able to prevent both the drive wheel and the driven wheel from wearing.off

### BACKGROUND OF THE INVENTION

1. Field of the Invention

This invention relates to a clutch device for a screw driver, particularly to one provided with a clutch in the interior of a shell for actuating a driving rod base and a driven wheel to operate correspondingly, and the clutch can automatically function to let the drive wheel of an electric tool drive or separate from the driven wheel after the screw driver drives a screw to a fixed position, able to prevent the drive wheel and the driven wheel from causing wear and making noises.

2. Description of the Prior Art

A conventional electric tool, as disclosed in a Taiwan patent No. 1293594, titled “HAND FASTENER DRIVING TOOL”, includes a motor 172 installed in the interior of an outer shell 120 and connected mechanically with a gear box 174 that is mechanically connected with a clutch 176. A driving shaft 126 has a clamping head 196 mechanically connected with a driving drill head 198 and is connected with a driven portion 250 of the clutch 176, and a recess 252 is formed in the clamping head 196 for receiving the driving drill head 198. What should be noted is that the driven portion 250 of the clutch 176 does not always contact directly with the driving portion 248 of the clutch 176 in various preferred embodiments of this invention. Typically, only when the driving portion and the driven portion of the clutch 176 are really engaged together, can the electric tool be started to operate. The conventional clutch can function only by means of corresponding operation of the driving shaft 126 and the driving portion 250, which will be automatically separated from each other after a screw is driven to a certain extent. However, when this conventional electric tool drives a screw to a certain depth, the driving rod of the electric tool cannot timely be separated from the screw; therefore, the end of the driving rod and the combining recess of the screw cannot smoothly and steadily contact with each other, likely to make noises and cause wear to the driving rod.

### SUMMARY OF THE INVENTION

The objective of this invention is to offer a clutch device for a screw driver, able to immediately separate the power of a screw driver from a driving rod and release the torsion force of the driving rod when the screw driver drives a screw to a preset depth, preventing the drive wheel of an electric tool and the driven wheel of a clutch from causing wear and making noises.

The clutch device for a screw driver in the present invention functions through corresponding operation of the driven wheel of the clutch and a driving rod. The clutch device of this invention is able to immediately separate the power of an electric tool from the driving rod and release the torsion force of the driving rod when the electric tool drives a screw to a certain depth in an object.

The clutch device is provided with a driving rod base bored with a center shaft groove for receiving a center shaft therein. After being extended into the center shaft groove, the center shaft will push positioning steel balls outward to make the positioning steel balls respectively protrude out of a positioning steel ball holes and received in inclined long holes of the driven wheel of the clutch. When the screw driver drives a screw to a certain depth in an object, the elastic member of the drive wheel of an electric tool will push the driven wheel to shift backward along the inclined long holes, instantly separating the drive wheel from the driven wheel and releasing the torsion force of the driving rod.

### BRIEF DESCRIPTION OF DRAWINGS

This invention will be better understood by referring to the accompanying drawings, wherein:

FIG. 1 is a cross-sectional view of a clutch device in the present invention;

FIG. 2 is a partial cross-sectional view of the clutch device in the present invention;

FIG. 3 is a partial exploded perspective view of the clutch device in the present invention;

FIG. 4 is a perspective view of a driven wheel of the clutch device in the present invention;

FIG. 5 is a cross-sectional view of the line marked A-A in FIG. 4;

FIG. 6 is a schematic view of an electric tool in a stand-by condition in the present invention;

FIG. 7 is a cross-sectional view showing the condition of a driving rod base and a driven wheel when the electric tool is in a stand-by condition shown in FIG. 6;

FIG. 8 is a schematic view of the electric tool ready to drive a screw in the present invention;

FIG. 9 is a cross-sectional view showing the condition of the driving rod base and the driven wheel when the electric tool drives the screw to the condition shown in FIG. 8;

FIG. 10 is a schematic view illustrating that the electric tool drives a screw to near a desired depth in the present invention;

FIG. 11 is a cross-sectional view showing the condition of the driving rod base and the driven wheel when the electric tool drives the screw to the condition shown in FIG. 10;

FIG. 12 is a schematic view illustrating that the electric tool drives the screw to a preset depth in the present invention;

FIG. 13 is a cross-sectional view showing the condition of the driving rod base and the driven wheel when the electric tool drives the screw to the condition shown in FIG. 12;

FIG. 14 is a schematic view illustrating that the electric tool drives the screw to a set depth in the present invention; and

FIG. 15 is a cross-sectional view showing the condition of the driving rod base and the driven wheel when the electric tool drives the screw to the condition shown in FIG. 14.

### DETAILED DESCRIPTION OF THE PREFERRED EMBODIMENT

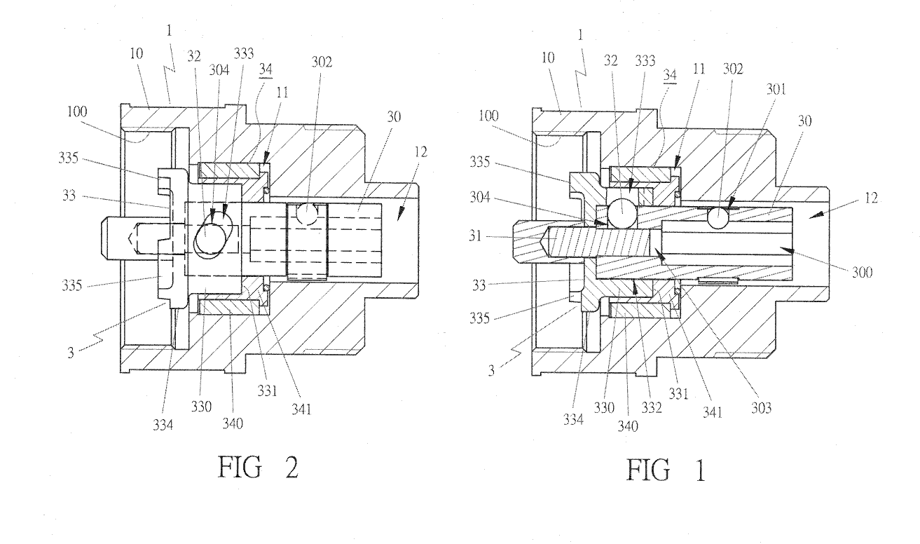

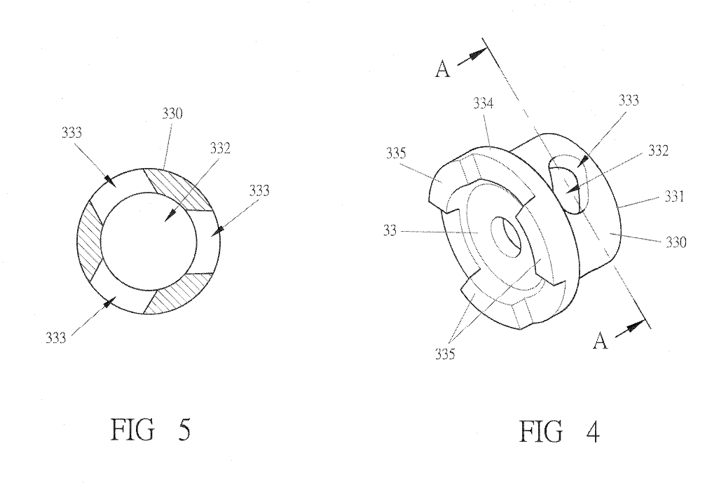

A preferred embodiment of a clutch device for a screw driver in the present invention, as shown in FIGS. 1-5, includes a shell 1 and a clutch 3 as main components combined together.

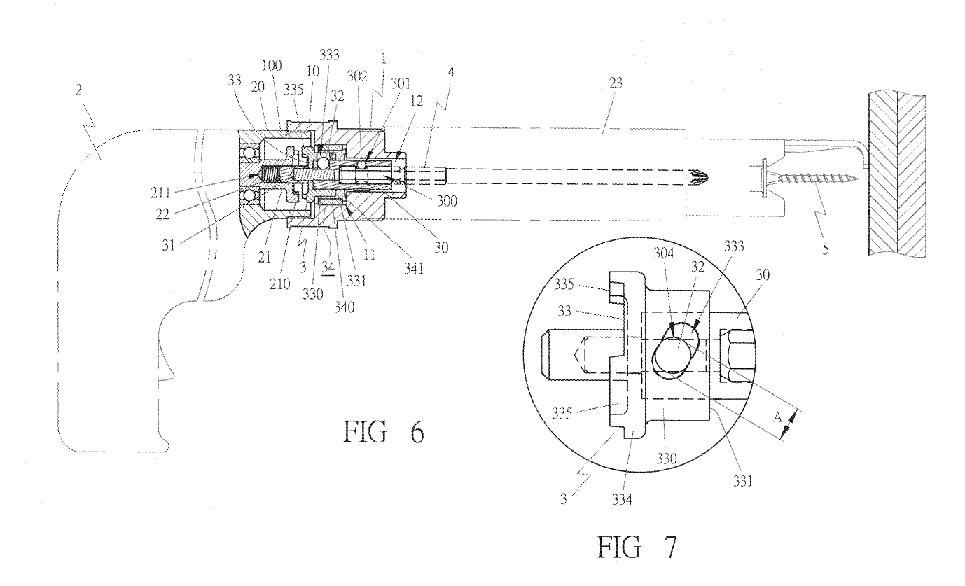

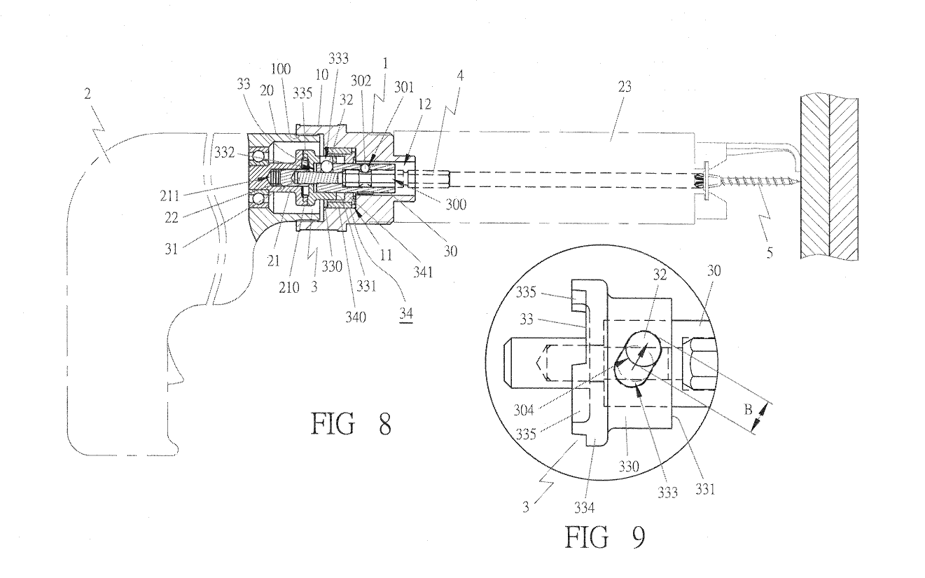

The shell 1 is provided with a combining circumference 10 formed with female threads 100 thereon for combining with the front toggle 20 of an electric tool 2, as shown in FIG. 6, so that the clutch device of this invention can match with the electric tool for mutual operation. The shell 1 is disposed with an accommodating chamber 11 for receiving the clutch 3 and has another end bored with a driving rod base hole 12 for receiving the driving rod base of the clutch 3.

The clutch 3 positioned in the accommodating chamber 11 of the shell 1 is provided with a driving rod base 30 bored with a driving rod groove 300 and bead holes 301 for round beads 302 to be positioned therein, as shown in FIGS. 1, 2 and 3. After a driving rod 4 is extended in the driving rod groove 300, the round beads 302 will firmly press the driving rod 4 and combine the driving rod 4 together with the driving rod base 30 to enable the driving rod 4 to drive a screw 5, as shown in FIG. 6. The driving rod base 30 is formed with a center shaft groove 303 for receiving a center shaft 31 therein, and the center shaft groove 303 and the driving groove 300 are provided reversely and different in inner diameter. Further, the driving rod base 30 of the clutch 3 is provided with a plurality of positioning steel ball holes 304 respectively positioned properly at a location of the center shaft groove 303 and extended out of the center shaft groove 303 for receiving positioning steel balls 32, which will be pushed outward to protrude out of the steel ball holes 304 after the center shaft 31 is extended in the center shaft groove 303, as shown in FIG. 1.

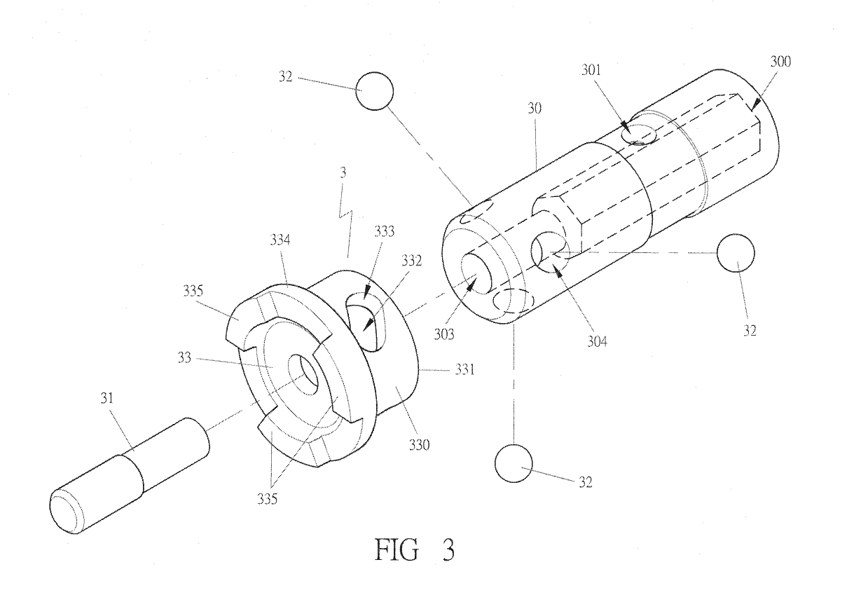

In addition, the clutch 3 is provided with a driven wheel 33 to be received in the accommodating chamber 11 of the shell 1, as shown in FIGS. 3, 4 and 5. A shock-preventing member 34 is assembled between the driven wheel 33 and the accommodating chamber 11, consisting of a shock-preventing plastic sleeve 340 fitted on the outer circumference 330 of the driven wheel 33, and a shock-preventing toggle 341 mounted on a rear wall surface 331 of the driven wheel 33, with the shock-preventing member 34 fixing the driven wheel 33 in position and producing effect of shock absorption. The outer circumference 330 of the driven wheel 33 is formed with an accommodating groove 332 for receiving one end of the driving rod base 30 and provided with a plurality of inclined long holes 333 extending outward from the accommodating groove 332, as shown in FIG. 5. After the center shaft 31 and the center shaft groove 303 are combined together, the positioning steel balls 32 will be respectively moved into the inclined long holes 333 to enable the driving rod base 30 and the driven wheel 33 to operate correspondingly. The driven wheel 33 is formed with a large outer circumference 334 having one side provided with teeth 335 to be engaged with the teeth of the drive wheel 21 of the electric tool 2 for operating mutually. The drive wheel 21 of the electric tool 2 is bored with an elastic member groove 211 for positioning an elastic member 22 therein for operating together with the center shaft 31.

After the clutch device of this invention is combined with an electric tool 2, the electric tool 2 is in a stand-by condition, as shown in FIGS. 6 and 7. Under this condition, the driving rod 4 is without any pressure, and the center shaft 31 is pushed outward and moved to a fixed position by expanding-out force of the elastic member 22 of the electric tool 2, and the positioning steel balls 32 of the clutch 3 are respectively moved to the location (A) in the inclined long holes 333 of the driven wheel 33. At this time, the driving rod 4 cannot be driven to operate even if the power of the electric tool is started.

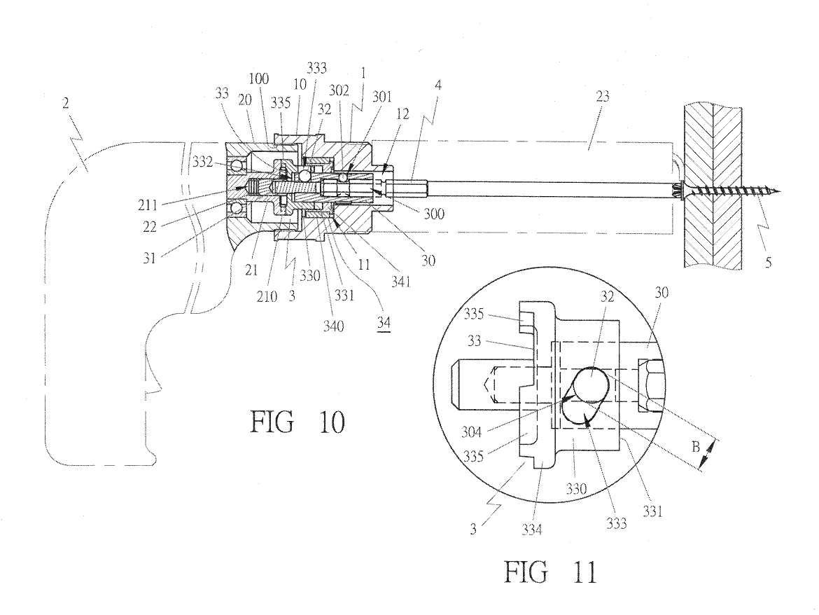

When the electric tool 2 is ready to drive a screw 5 and after the screw 5 resists against a work piece 6, the driving rod 4 will be actuated to move backward to let the center shaft 31 and the driving rod 4 compress the elastic member 22 of the electric tool 2 to contract to make the teeth 335 of the driven wheel 33 engaged with the teeth 210 of the drive wheel 21 of the electric tool 2, letting the positioning steel balls 32 of the clutch 3 respectively moved to the location (B) of in inclined long holes 333 of the driven wheel 33. At this time, the electric tool 2 can be started to drive the driving rod 4 to carry out screw driving work. The positioning steel balls 32 of the clutch 3 are constantly kept at the location (B) in the inclined long holes 333 of the driven wheel 33 until the electric tool 2 drives the screw 5 to near a preset depth in an object, as shown in FIGS. 10 and 11.

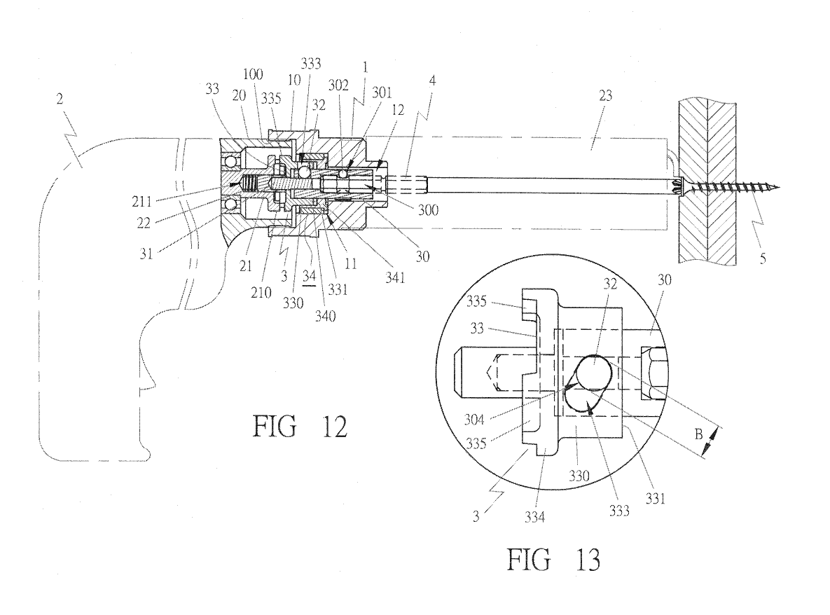

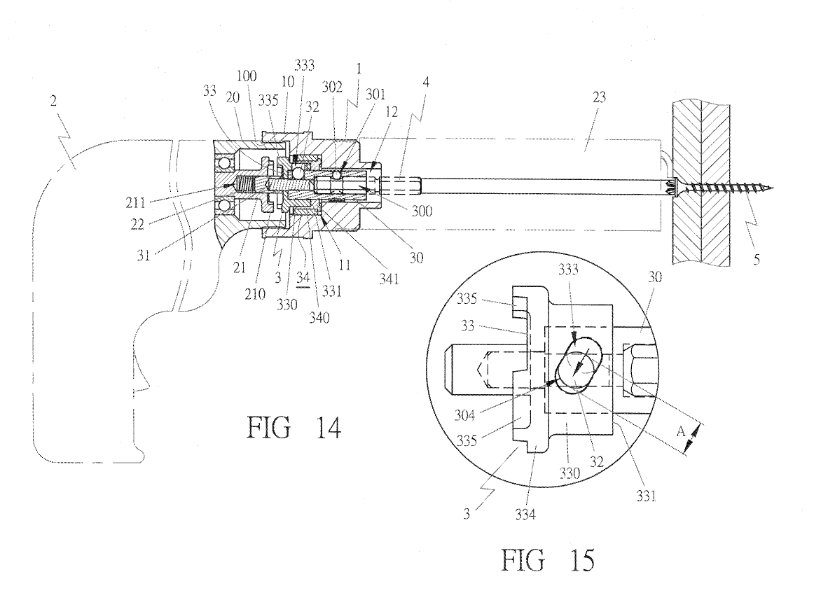

When the electric tool 2 drives the screw 5 to reach a preset depth, the drive-depth adjusting member 23 of the electric tool 2, which is a conventional technique and unnecessary to make a superfluous statement, will no longer be moved forward. At this time, the driven wheel 33 of the clutch 3 and the drive wheel 21 of the electric tool 2 are at a location ready to be disengaged, while the positioning steel balls 32 are respectively at the location (B) of in the inclined long holes 333, as shown in FIGS. 12 and 13, and the driven wheel 33 cannot be driven any more and the center shaft 31 is pushed out by the elastic member 22 of the electric tool 2. At this time, the drive wheel 21 of the electric tool 2 and the driving rod base 30 of the clutch 3 are stationary in position, while the driven wheel 33 is immediately disengaged from the drive wheel 21 and the positioning steel balls 32 are respectively kept at the location (A) in the inclined long hole 333, as shown in FIGS. 14 and 15, thus able to avoid wear and noises caused by incomplete disengagement of the drive wheel 21 and the driven wheel 33. After the driven wheel 33 is completely disengaged from the drive wheel 21, the center shaft 31 will be pushed out by the elastic member of the electric tool and the driven wheel 33 will be actuated to recover its original position, which is the working principle of a whole clutch system.

While the preferred embodiment of the invention has been described above, it will be recognized and understood that various modifications may be made therein and the appended claims are intended to cover all such modifications that may fall within the spirit and scope of the invention.

What is claimed is:

1. A clutch device for a screw driver comprising:
a shell provided with a combining circumference to be combined with an electric tool, said shell formed with an accommodating chamber for receiving a clutch, said accommodating chamber having one end bored with a driving rod hole; and
said clutch received in said accommodating chamber of said shell, said clutch composed of a driving rod base, a driven wheel and a center shaft, said driving rod base disposed with a driving rod groove and a center shaft groove, said center shaft groove receiving said center shaft therein, said driving rod base bored with positioning steel ball holes in said center shaft groove, said positioning steel ball holes respectively receiving a positioning steel ball therein, said positioning steel balls pushed outward by said center shaft to protrude out of said positioning steel ball holes, said driven wheel positioned in said accommodating chamber of said shell, said driven wheel fixed in position by a shock-preventing member, said driven wheel formed with inclined long holes, positioning steel balls respectively positioned in said inclined long holes, said position balls possible to move in said inclined holes after said center shaft and said center shaft groove are combined together, thus said driving rod base and said driven wheel being able to be operated correspondingly, said clutch able to function automatically to let said driven wheel driven by or separated from a drive wheel of said electric tool when a screw is driven to a needed location in an object by a screw driver, said drive wheel and said driven wheel prevented from wearing and making noises.

2. A clutch device for a screw driver as claimed in claim 1, wherein said combining circumference of said shell is provided with female threads to be combined with a front toggle of said electric tool.

3. A clutch device for a screw driver as claimed in claim 1, wherein said center shaft groove and said driving rod groove of said driving rod base of said clutch are provided reversely.

4. A clutch device for a screw driver as claimed in claim 1, wherein said driven wheel of said clutch is formed with an outer circumference having an accommodating groove for receiving one end of a driving rod.

5. A clutch device for a screw driver comprising”
a shell formed with a combining circumference to be combined with an electric tool, said shell provided with an accommodating chamber for receiving a clutch, said accommodating chamber having one end bored with a driving rod hole;
a said clutch received in said accommodating chamber of said shell, said clutch composed of a driving rod base, a driven wheel and a center shaft, said driving rod base bored with a driving rod groove and a center shaft groove, said center shaft groove and said driving rod groove provided reversely, said center shaft groove bored with positioning steel ball holes respectively for receiving a positioning steel ball therein, said center shaft extended in said center shaft groove to push said positioning steel balls outward and make said positioning steel balls respectively protrude out of said positioning steel ball holes, said driven wheel received in said accommodating chamber of said shell, said driven wheel fixed in place by a shock-preventing member, said driven wheel bored with inclined long holes, said positioning steel balls respectively being possible3 to move in said inclined long holes after said center shaft and said center shaft groove are combined together; and
Said driven wheel of said clutch pushed out by an elastic member of a drive wheel of said electric tool when said electric tool drives a screw to a preset depth in an object, said positioning steel balls in said inclined long hole of said driven wheel shifted from a location (A) to a location (B) or vice versa for carrying out engaging and disengaging with said drive wheel of said electric tool so as to prevent said driving rod from driving a screw continuously and causing wear to both said drive wheel and said driven wheel, further, said elastic member of said electric tool pushing said center shaft outward to prevent said electric tool from keeping on driving said clutch.

6. A clutch device for a screw driver as claimed in claim 5, wherein said combining circumference of said shell is provided with female threads for combining with a front toggle of said electric tool.

7. A clutch device for a screw driver as claimed in claim 5, wherein said driving rod base of said clutch is provided with a driving rod groove bored with round bead holes respectively receiving a round bead therein, said round beads firmly resisting against said driving rod to combine said driving rod tightly together with said driving rod base after said driving rod extended and positioned in said driving rod groove.

8. A clutch device for a screw driver as claimed in claim 5, wherein said driving rod base of said clutch is bored with a plurality of positioning steel ball holes respectively extending out of said center shaft groove.

9. A clutch device for a screw driver as claimed in claim 5, wherein said shock-preventing member consists of a shock-preventing plastic sleeve and a shock-preventing toggle, said shock-preventing plastic sleeve is fitted on the outer circumference of said driven wheel, and said shock-preventing toggle is positioned on a rear wall surface of said driven wheel.

10. A clutch for a screw driver as claimed in claim 5, wherein said driven wheel is formed with a large outer circumference having one side provided with teeth for engaging with teeth of said drive wheel of said electric tool.
